(19) United States
(12) Patent Application Publication
(10) Pub. No.: US 2011/0299269 A1
(43) Pub. Date: Dec. 8, 2011

(54) DISPLAY APPARATUS AND METHOD FOR PRODUCING THE SAME

(76) Inventors: Toshio HATA, Osaka (JP); Masayuki Ito, Osaka (JP)

(21) Appl. No.: 13/152,567

(22) Filed: Jun. 3, 2011

(30) Foreign Application Priority Data
Jun. 3, 2010 (JP) 2010-128025

(51) Int. Cl. G02F 1/13357; B29C 65/48

(52) U.S. Cl. 362/97.1; 156/182

(57) ABSTRACT

A display apparatus according to the present invention includes a surface mount-type light-emitting device that is surface-mounted to a wiring substrate, a lens unit disposed opposing the surface mount-type light-emitting device, and a frame body portion disposed surrounding a circumference of the lens unit. The frame body portion and the lens unit are formed as a single body to form a lens array module, the frame body portion includes a positioning pin that projects toward the wiring substrate, and the wiring substrate includes a positioning recess portion in a position corresponding to the positioning pin.

### CROSS-REFERENCE TO RELATED APPLICATIONS

This application claims priority under 35 U.S.C. §119(a) on Patent Application No. 2010-128025 filed in Japan on Jun. 3, 2010, the entire contents of which are herein incorporated by reference.

### BACKGROUND OF THE INVENTION

1. Field of the Invention

The present invention relates to a display apparatus provided with a wiring substrate on which a surface mount-type light-emitting device has been disposed, and a method for producing the display apparatus.

2. Description of the Related Art

Conventionally, an illumination apparatus using light-emitting elements is known. Also, in a display apparatus in which a plurality of light-emitting elements are arrayed on a wiring substrate in the form of a matrix, the light-emitting elements are selectively turned on, thereby enabling display of a color image and the like. In particular, a sharp image having high luminance can be obtained by using a light-emitting diode (LED) as the light-emitting element, which is disclosed in, for example, JP 10-233534A (hereinafter referred to as “Patent Document 1”), JP 2001-290443A (hereinafter referred to as “Patent Document 2”) and JP 2009-253098A (hereinafter referred to as “Patent Document 3”).

FIG. 11 is a schematic cross-sectional view that shows the configuration of a conventional display apparatus. Note that hatching is omitted for the sake of easy understanding.

A conventional display apparatus 100 is provided with a substrate 102 on which LED lamps 101 are disposed, a case 103 that covers the circumference of the substrate 102, and fixes the substrate 102, a filler 104 formed by filling a space between the LED lamps 101, the substrate 102 and the case 103 with resin, and light-shielding members 105 disposed between the LED lamps 101.

In the display apparatus disclosed in Patent Document 1, a filler 104 containing an infrared reflection member is applied to the conventional display apparatus 100 for improving weather resistance.

Also, in the display apparatus disclosed in Patent Document 2, the substrate 102 is covered with the filler 104 from the back face of the inner wall of the case 103 in order to prevent water from coming in.

Also in the display apparatus disclosed in Patent Document 3, lead frames 106 of the LED lamps 101 are covered with the filler 104 having insulation properties in order to prevent leakage of electromagnetic waves from the LED lamps 101, and the filler 104 is filled to a height sufficient to cover the lead frames 106.

However, with conventional display apparatuses, luminous intensity at the front of the apparatuses has been insufficient. Also, since the filler is formed by filling resin, it has been necessary to control the amount of resin in order to insure luminance, adhesiveness and the like. In other words, if the amount of resin is large, the LED lamps are hidden, causing a drop in luminance, and if the amount of resin is small, the lead frames are exposed, causing a problem in insulation, water resistance, adhesiveness, and the like.

### SUMMARY OF THE INVENTION

The present invention has been made in view of the technical problems as described above, and it is an object thereof to provide a highly reliable display apparatus having improved visibility and weather resistance.

Also, another object of the present invention is to provide a method for producing a highly reliable display apparatus having improved visibility and weather resistance.

A display apparatus according to the present invention includes a surface mount-type light-emitting device that is surface-mounted to a wiring substrate; a lens unit disposed opposing the surface mount-type light-emitting device; and a frame body portion disposed surrounding a circumference of the lens unit, wherein the frame body portion and the lens unit are formed as a single body to form a lens array module, the frame body portion includes a positioning pin that projects toward the wiring substrate, and the wiring substrate includes a positioning recess portion in a position corresponding to the positioning pin.

With this configuration, positional deviation of the surface mount-type light-emitting device with respect to the lens unit can be suppressed by the positioning pin and the positioning recess portion. Accordingly, luminous intensity at the front of the lens unit can be improved, and thus visibility of the display apparatus can be improved. Also, a waterproof effect is achieved by the lens array module formed by forming the frame body portion and the lens unit as a single body, and thus weather resistance can be improved

With the display apparatus according to the present invention, a configuration may be adopted in which the lens unit is disposed in a form of a dot matrix, and the frame body portion is formed in a grid form, and a plurality of the positioning pins and a plurality of the positioning recess portions are provided.

This configuration is suitable for realizing a large screen of the display apparatus, and since the position of the surface mount-type light-emitting device with respect to the lens unit is fixed at plural locations, it is possible to suppress positional deviation for all surface mount-type light-emitting devices.

The display apparatus according to the present invention may include a filled resin portion formed by filling a space between the surface mount-type light-emitting device and the lens unit with synthetic resin, and the wiring substrate may include a substrate through hole disposed around the surface mount-type light-emitting device.

With this configuration, since the surface mount-type light-emitting device is covered with synthetic resin, the surface mount-type light-emitting device can be reliably protected, and the wiring substrate can be attached to the lens array module by hardening the synthetic resin. Also, excessive synthetic resin can be adjusted with the substrate through hole, thereby reducing air bubbles remaining in the synthetic resin

With the display apparatus according to the present invention, the wiring substrate and the lens array module may be fixed with a screw.

With this configuration, the wiring substrate and the lens array module can be firmly fixed with the screws.

With the display apparatus according to the present invention, a groove is preferably formed in the frame body portion.

With this configuration, rainwater and the like can be drained and easily removed by the groove, thereby improving whether resistance.

With the display apparatus according to the present invention, a configuration may be adopted in which a visor portion disposed corresponding to the frame body portion is provided, the visor portion includes a projection portion that projects so as to be fitted into the groove of the frame body portion, and the projection portion is attached to the groove.

With this configuration, a reduction in visibility due to irradiation light can be suppressed. Also, the projection portion allows easy attachment of the visor portion.

A method for producing a display apparatus according to the present invention is a method for producing a display apparatus that includes a surface mount-type light-emitting device that is surface-mounted to a wiring substrate; a lens unit disposed opposing the surface mount-type light-emitting device; and a frame body portion disposed surrounding a circumference of the lens unit, the method including the steps of preparing a lens array module in which the lens unit and the frame body portion are formed as a single body; preparing the wiring substrate to which the surface mount-type light-emitting device is surface-mounted; filling an opening in the lens array module with synthetic resin; disposing the surface mount-type light-emitting device in the synthetic resin filled in the opening by superposing the wiring substrate on the lens array module such that a positioning pin provided in the frame body portion corresponds to a positioning recess portion provided in the wiring substrate; and hardening the synthetic resin, thereby attaching the lens array module to the wiring substrate.

With this configuration, it is possible to attach the lens array module to the wiring substrate when the filled resin portion is formed by hardening synthetic resin, and thus the steps can be simplified.

With the method for producing a display apparatus according to the present invention, synthetic resin may be applied to the positioning pin in the filling step.

With this configuration, since the area for attaching the lens array module to the wiring substrate is increased, the connection strength between the lens array module to the wiring substrate is increased.

### BRIEF DESCRIPTION OF THE DRAWINGS

FIG. 1A is a plan view of a display apparatus according to an embodiment of the present invention, and FIG. 1B is a side view from the direction of arrow B in FIG. 1A.

FIG. 2A is a plan view of a surface mount-type light-emitting device mounted on the display apparatus according to an embodiment of the present invention, and FIG. 2B is a see-through side view when viewed in a see-through manner from the direction of arrow B in FIG. 2A.

FIG. 3 is a partial enlarged plan view showing a partially enlarged view of a state in which the surface mount-type light-emitting devices as shown in FIGS. 2A and 2B have been mounted to a wiring substrate.

FIG. 4A is a plan view of a lens unit applied to the display apparatus according to an embodiment of the present invention, FIG. 4B is a cross-sectional view at arrows B-B in FIG. 4A, and FIG. 4C is a cross-sectional view at arrows C-C in FIG. 4A.

FIG. 5A is a plan view of a modified example of the lens unit shown in FIGS. 4A to 4C, FIG. 5B is a cross-sectional view at arrows B-B in FIG. 5A, and FIG. 5C is a cross-sectional view at arrows C-C in FIG. 5A.

FIG. 6A is a plan view of a part of a lens array module formed by double molding lens units and a frame body portion, applied to the display apparatus according to an embodiment of the present invention, and FIG. 6B is a see-through side view when viewed in a see-through manner from the direction of arrow B in FIG. 6A.

FIG. 7A is an enlarged plan view of a portion of the lens array module shown in FIGS. 6A and 6B, and FIG. 7B is a cross-sectional view at arrows B-B in FIG. 7A.

FIG. 8A is a schematic side view illustrating a state in which, in a production step of the display apparatus according to an embodiment of the present invention, a wiring substrate to which a lens array module has been attached is attached to a case, and a filled resin portion has been formed by filling a space between the surface mount-type light-emitting devices and the lens units with translucent resin, and FIG. 8B is an enlarged cross-sectional view of the portion of reference sign B in FIG. 8A.

FIG. 9A is a schematic side view of a side face that illustrates a state in which, in a production step of the display apparatus according to an embodiment of the present invention, visor portions have been attached, and FIG. 9B is an enlarged cross-sectional view of the portion of reference sign B in FIG. 9A.

FIGS. 10A to 10E illustrate an embodiment of the method for producing a display apparatus of the present invention over time, and are schematic cross-sectional views of each production step.

FIG. 11 is a schematic cross-sectional view that shows a configuration of a conventional display apparatus.

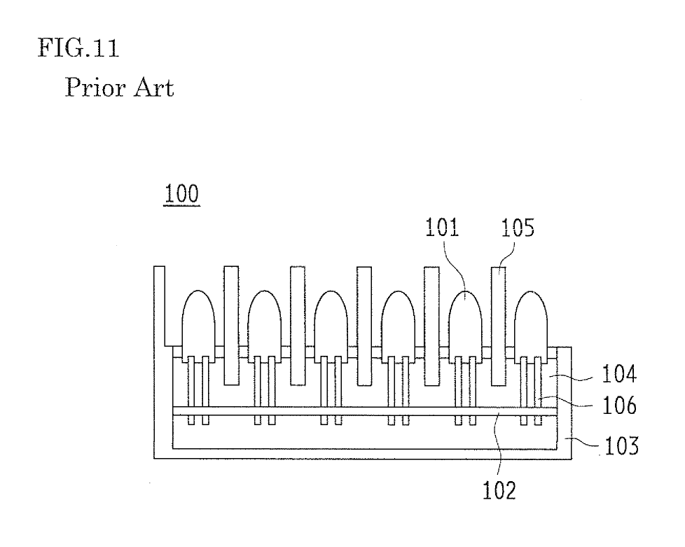

### DESCRIPTION OF THE PREFERRED EMBODIMENTS

Hereinafter, an embodiment(s) of the present invention will be described based on the accompanying drawings.

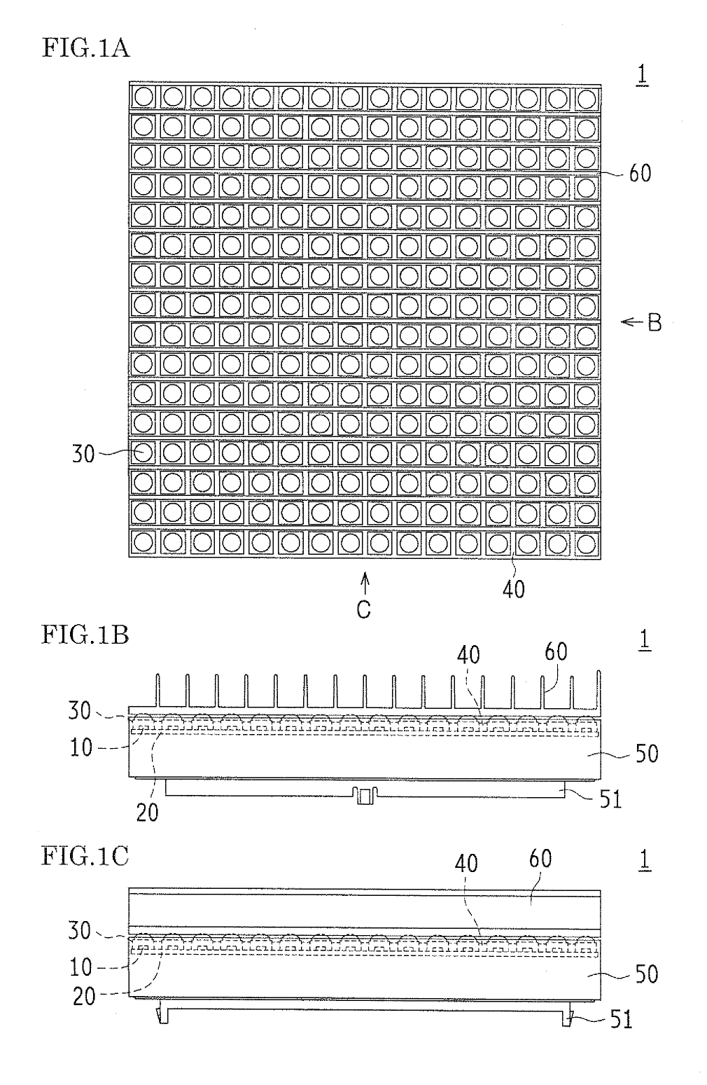

FIG. 1A is a plan view of a display apparatus according to an embodiment of the present invention, and FIG. 1B is a side view when viewed from the direction of arrow B in FIG. 1A.

The display apparatus 1 according to the present embodiment is provided with surface mount-type light-emitting devices 10 that are surface mount-type light-emitting devices, a wiring substrate 20 where the surface mount-type light-emitting devices 10 have been mounted, lens units 30 that have been disposed in front of the surface mount-type light-emitting devices 10, and a frame body portion 40 disposed surrounding the circumference of the lens unit 30. The wiring substrate 20 is attached to a case 50, and visor portions 60 are disposed on the front side of the lens units 30. The case 50 is provided with an engaging portion 51 that allows easy attachment to an electronic device where the display apparatus 1 is to be installed.

In the present embodiment, the surface mount-type light-emitting devices 10 are disposed in the form of a dot matrix having 16 vertical surface mount-type light-emitting devices 10 (16 rows) and 16 horizontal surface mount-type light-emitting devices 10 (16 columns), such that a total of 256 surface mount-type light-emitting devices 10 are mounted to the wiring substrate 20. Also, 16 visor portions 60 are disposed corresponding to the 16 rows in the vertical direction (in the drawings).

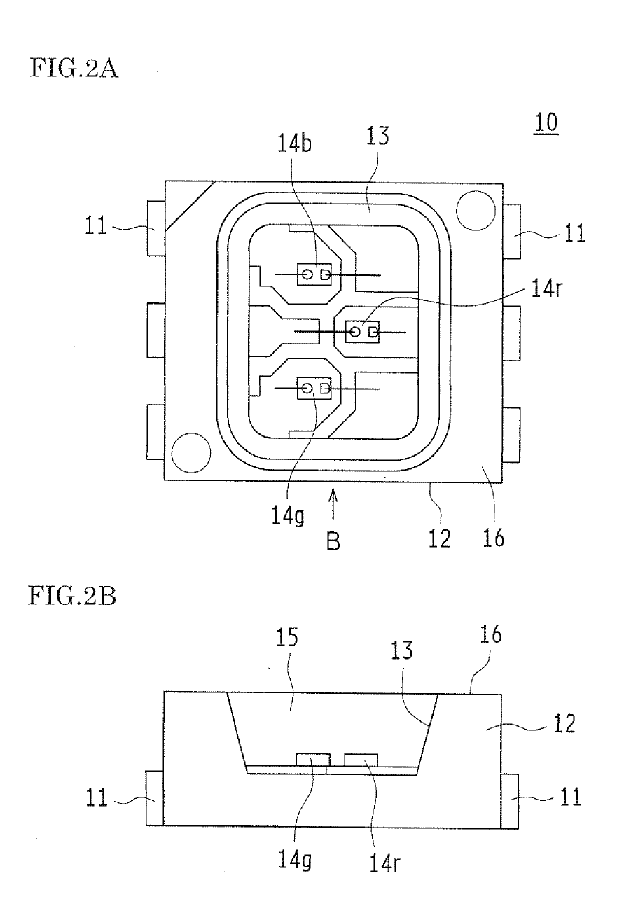

As described above, the display apparatus 1 according to the present embodiment is provided with the surface mount-type light-emitting devices 10 that have external terminals 11 (see FIGS. 2A and 2B) for surface mounting, and the wiring substrate 20, and is also provided with the lens units 30 that have been disposed opposing the surface mount-type light-emitting devices 10, and the frame body portion 40 disposed surrounding the lens units 30.

With the configuration described above, in the display apparatus 1, luminous intensity in front of the lens units 30 is improved by collecting light that has been emitted from the surface mount-type light-emitting devices 10, so display can be performed while clearly distinguishing between lit and non-lit portions, and also, the connection structure is simplified so that workability and reliability of connections (mounting) are improved, and the display apparatus can be made more thin.

FIG. 2A is a plan view of surface mount-type light-emitting devices mounted to a display apparatus according to the present invention, and FIG. 2B is a see-through side view when viewed in a see-through manner from the direction of arrow B in FIG. 2A.

The surface mount-type light-emitting devices 10 have the external terminals 11 for surface mounting. Also, each surface mount-type light-emitting device 10 is provided with a package portion 12 that has been formed in an appropriate shape, and a recess portion 13 that has been formed in the package portion 12. Mounted to the recess portion 13 are a semiconductor light-emitting element 14r that emits red (R) light, a semiconductor light-emitting element 14g that emits green (G) light, and a semiconductor light-emitting element 14b that emits blue (B) light.

In the case of a road display (particularly when it is necessary to arouse attention using text, for example), the color orange or red is often used for the color of text, in consideration of visibility and ability to arouse attention. Ordinarily, the color orange is generated by mixing the colors red and green. Accordingly, it is possible to improve visibility by disposing the color red in the center. In the surface mount-type light-emitting device 10 according to the present embodiment, improved visibility is achieved by disposing the semiconductor light-emitting element 14r in the center, and disposing the semiconductor light-emitting element 14g and the semiconductor light-emitting element 14b on respective sides of the semiconductor light-emitting element 14r.

The semiconductor light-emitting element 14r, the semiconductor light-emitting element 14g, and the semiconductor light-emitting element 14b are mounted to a bottom face of the recess portion 13 in the state of chips obtained by dividing a semiconductor substrate, and are connected to the external terminals 11 via wiring, for example. The recess portion 13 is filled with a translucent resin portion 15, and thus the semiconductor light-emitting element 14r, the semiconductor light-emitting element 14g, and the semiconductor light-emitting element 14b are protected from the external environment. In this example, one each of the semiconductor light-emitting element 14r, the semiconductor light-emitting element 14g, and the semiconductor light-emitting element 14b are shown, but a plurality of each can be disposed.

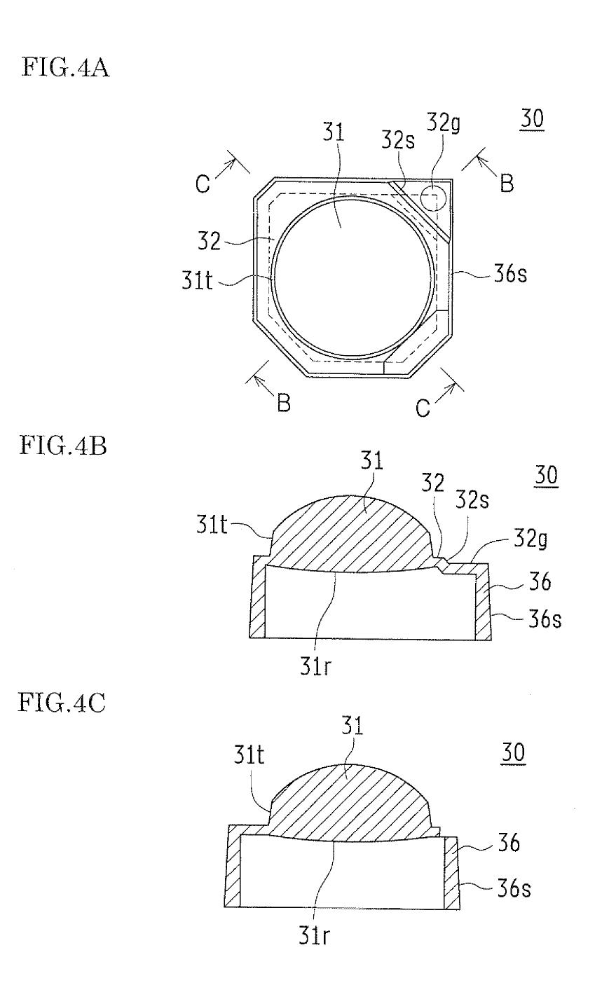

As shown, a rectangular shape is adopted for the opening of the recess portion 13, so it is possible to cause a light-emitting pattern to grow wider in the lateral direction. With this configuration, it is possible to cause the light-emitting pattern to grow wider in the lateral direction than when a circular shape is adopted. Also, by adopting a rectangular shape for the opening of the recess portion 13, it is possible to improve light-guiding for a holding portion 32 (see FIGS. 4A to 4C) that has a rectangular shape, and so it is possible to improve light intensity of a curved face portion 31, thus improving light extracting efficiency.

A similar shape to that of the curved face portion 31 (see FIGS. 4A to 4C) of the lens unit 30 can also be adopted as the shape of the opening of the recess portion 13. That is, by making the shape of the opening of the recess portion 13, which defines the light-emitting pattern, oppose the outer shape of the curved face portion 31, it is possible to reduce loss of optical coupling between the surface mount-type light-emitting device 10 (the shape of the opening of the recess portion 13) and the curved face portion 31.

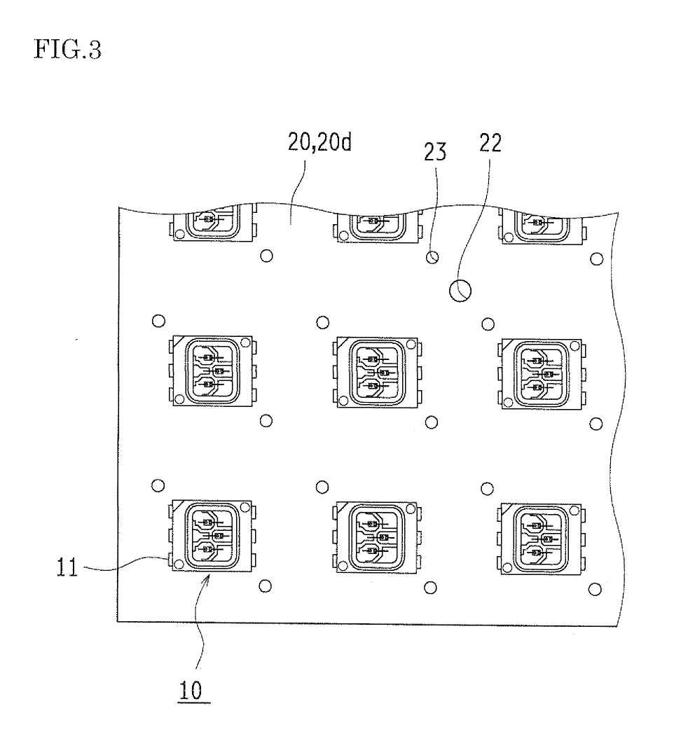

Also, a black portion 16 is formed on the surface (outside of the surface of the recess portion 13) of a package portion 12, thus improving recognition (identification) of light emitted from the recess portion 13. An appropriate shape can be adopted for the package portion 12, as long as the package portion 12 can be surface-mounted to the wiring substrate 20. In FIG. 3, the surface of the package portion 12 is shown in a flat state, but for example, a configuration can also be adopted in which the translucent resin portion 15 has some kind of lens properties (a convex shape) on the inside of the black portion 16.

As described above, in the surface mount-type light-emitting devices 10 mounted to the display apparatus 1, the plurality of semiconductor light-emitting elements 14r, semiconductor light-emitting elements 14g, and semiconductor light-emitting elements 14b that emit different colors of light from each other are provided. Accordingly, the display apparatus 1 is capable of performing multi-color display. That is, one group of a semiconductor light-emitting element 14r, a semiconductor light-emitting element 14g, and a semiconductor light-emitting element 14b can be used to configure one pixel that performs multi-color display.

FIG. 3 is a partial enlarged plan view showing a partially enlarged view of a state in which surface mount-type light-emitting devices as shown in FIGS. 2A and 2B have been mounted to a wiring substrate.

Because the surface mount-type light-emitting devices 10 have the external terminals 11 for surface mounting, the surface mount-type light-emitting devices 10 can be placed as-is on the surface (a display face 20d) of the wiring substrate 20, and mounted (connected) thereto. Note that for the sake of easy understanding, FIG. 3 shows an enlarged view of only part (the disposed state of the surface mount-type light-emitting devices 10 near an end portion of the wiring substrate 20) of the wiring substrate 20 (the display face 20d).

Because the surface mount-type light-emitting device 10 is a surface mount-type, the height of the surface mount-type light-emitting device 10 at the wiring substrate 20 is the height of the package portion 12 of the surface mount-type light-emitting device 10. Accordingly, thickness can be reduced along the display face 20d of the wiring substrate 20.

The height of a molded-type LED lamp (molded-type light-emitting device) generally adopted in a conventional display apparatus is ordinarily 24 mm, because it is necessary to consider lead length. Accordingly, the height from the substrate surface when a molded-type LED lamp has been mounted to the wiring substrate 20 is 14 mm, obtained by subtracting 10 mm of lead length. On the other hand, the height of the surface mount-type light-emitting device 10 is set to 1.4 mm, for example. Accordingly, the height from the substrate surface when the surface mount-type light-emitting device 10 has been mounted to the wiring substrate 20 can be set to 1.4 mm. That is, the thickness of the display apparatus 1 can be reduced by adopting the surface mount-type light-emitting devices 10.

The weight of a molded-type LED lamp is, for example, 0.28 g (grams), while the weight of the surface mount-type light-emitting device 10 is, for example, 0.025 g (grams). Accordingly, by adopting the surface mount-type light-emitting devices 10, it is possible for the weight from the surface mount-type light-emitting devices 10 to be 1/10th of the weight in a conventional example. In this manner, by adopting the surface mount-type light-emitting devices 10, it is possible to reduce the weight of the display apparatus 1. Also, because reduced cost can be realized, when the display apparatus 1 is adopted in a road information display apparatus, it is possible to lower construction costs related to road construction.

The plan view shape of the wiring substrate 20 is, for example, a 160 mm×160 mm rectangle (see FIGS. 1A and 1B), and the thickness of the wiring substrate 20 is, for example, 1 mm. Also, the surface mount-type light-emitting devices 10 that have been disposed on the display face 20d in the form of a 16 row×16 column dot matrix are disposed at a pitch of 10 mm in the vertical direction and 10 mm in the horizontal direction. Note that the arrangement of the surface mount-type light-emitting devices 10 is not limited to the form of a dot matrix; an arbitrary pattern can be adopted according to the display specification of the display apparatus in which the surface mount-type light-emitting devices 10 will be applied.

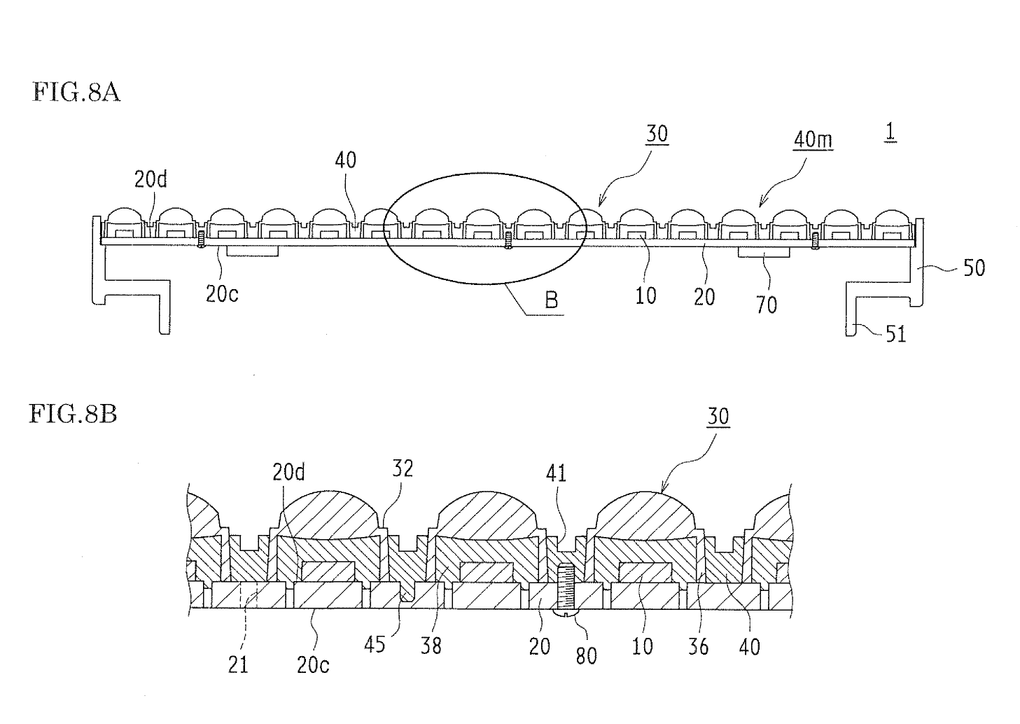

The wiring substrate 20 has a wiring pattern (not shown) for arranging and fixing (connecting) the surface mount-type light-emitting devices 10. That is, the external terminals 11 of the surface mount-type light-emitting devices 10 are electrically and mechanically connected to the wiring substrate 20 (wiring pattern) by electrically conductive material such as solder. Also, drive circuits 70 (see FIGS. 8A and 8B) that supply power via the wiring pattern to the surface mount-type light-emitting devices 10 are mounted to a back face 20c (see FIGS. 8A and 8B) on the opposite side as the display face 20d.

The wiring substrate 20 preferably has high mechanical strength and is deformed little by heat. Specifically, a printed substrate employing insulating synthetic resin, ceramic, glass, aluminum alloy, or the like, that is, a rigid substrate, can be suitably used.

In the wiring substrate 20, positioning recess portions 22 are disposed in the positions corresponding to positioning pins 45 as described later, and substrate through holes 23 are disposed around the surface mount-type light-emitting devices 10.

In the present embodiment, two substrate through holes 23 are provided for each surface mount-type light-emitting device 10, for example, and 512 substrate through holes 23 are disposed corresponding to the surface mount-type light-emitting devices 10. Also, sixteen positioning recess portions 22 are disposed.

The display face 20d is disposed corresponding to the display face of the display apparatus 1. Accordingly, in order to improve contrast, damp-proofing, and insulation, it is preferable that the wiring substrate 20 is formed with a substantially black resin having damp-proofing properties. Also, the substantially black resin can be applied to the surface (display face 20d) of the wiring substrate 20 in the form of a solder resist or a marking ink.

FIG. 4A is a plan view of a lens unit applied to the display apparatus according to an embodiment of the present invention, FIG. 4B is a cross-sectional view at arrows B-B in FIG. 4A, and FIG. 4C is a cross-sectional view at arrows C-C in FIG. 4A.

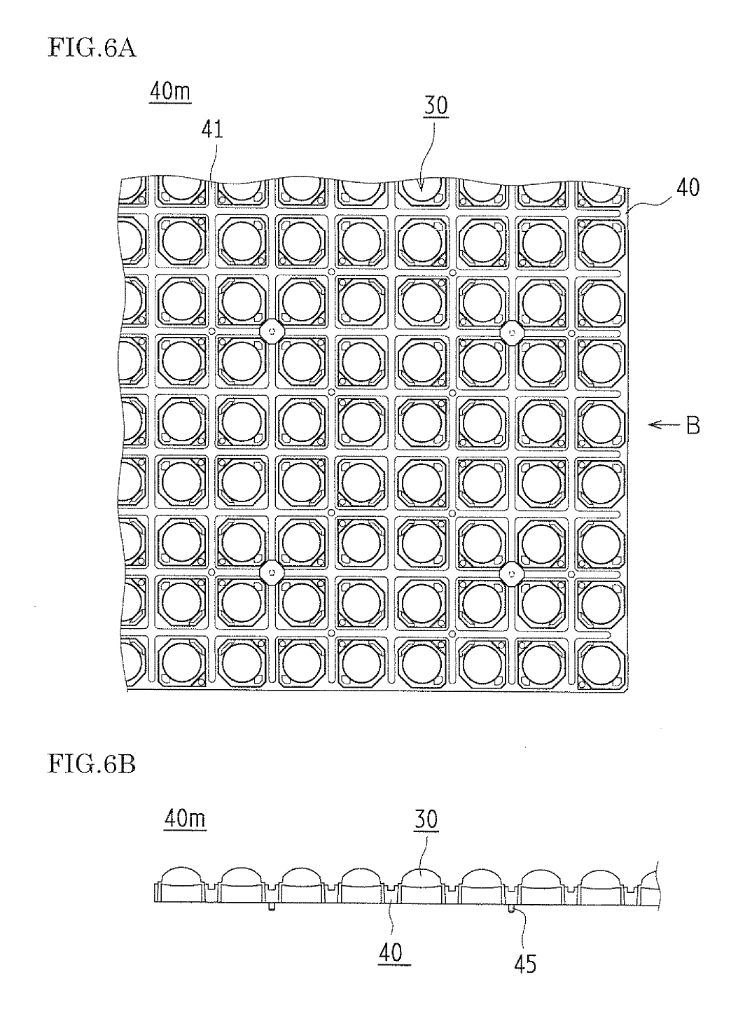

The lens unit 30 according to the present embodiment is provided with the curved face portion 31 (curved face portion 31 having a curved face) that is formed as a convex lens and has light-collecting properties, and the holding portion 32 that is extended from the curved face portion 31 to the frame body portion 40 (see FIGS. 6A and 6B), and holds the curved face portion 31. Accordingly, in the display apparatus 1, it is possible to form the lens units 30 and the frame body portion 40 with high precision in a state in which light-collecting properties are insured, so display properties (display precision) can be improved.

The holding portion 32 is provided with a skirt portion 36 that is extended to the side of the wiring substrate 20 and makes contact with the frame body portion 40 (see FIGS. 6A and 6B). Accordingly, it is possible to easily and precisely form the lens units 30 and the frame body portion 40, and it is possible to easily and precisely form filled resin portions 38 (see FIGS. 8A and 8B).

Also, the skirt portion 36 is configured to become larger to the outside toward the side of the wiring substrate 20 relative to the side of the holding portion 32. That is, a surface 36s of the skirt portion 36 is inclined so as to widen from the holding portion 32 toward the wiring substrate 20. Accordingly, it is easy to form the frame body portion 40 and the skirt portion 36. That is, when forming the lens unit 30 and the frame body portion 40 as a single body using a double molding method, it is possible to improve separation from an injection molding die. The inclination angle of the surface 36s is set to two degrees.

The skirt portion 36 (lens unit 30), in consideration of adaptability to the frame body portion 40, is made frame-like, and is appropriately flattened (chamfered) in order to make orientation clear. The surface mount-type light-emitting device 10 is disposed on the inside of the skirt portion 36, and by filling with translucent resin (synthetic resin), the filled resin portion 38 is formed (see FIGS. 8A and 8B). The skirt portion 36 is desirably formed on all sides, but this is not a limitation. That is, any configuration is acceptable as long as the skirt portion 36 can be positioned relative to the frame body portion 40.

The lens material of the lens unit 30 is a polycarbonate resin containing a UV-absorbing agent. Accordingly, it is possible to prevent UV rays included in outside light from being incident on the surface mount-type light-emitting device 10 (see FIGS. 8A and 8B) disposed within the lens unit 30. Phenyl salicylate is applied as the UV-absorbing agent.

Resin containing a UV-absorbing agent is formed by mixing and dispersing the UV-absorbing agent in polycarbonate resin used as translucent resin material. As the UV-absorbing agent, it is possible to apply various organic UV-absorbing agents, such as salicylates, triazines, benzophenones, and cyanoacrylates.

As the lens material, it is possible to use a resin material on which a molding process can be performed, such as an acrylic or polycarbonate. Acrylic has excellent weather resistance, but poor impact resistance and heat resistance, and moreover, has a refractive index of 1.49, which is less than the refractive index of 1.59 for polycarbonate, so when attempting to have the same light-collecting properties (lens properties), lens thickness is greater than in the case of polycarbonate.

Polycarbonate has excellent impact resistance and heat resistance, but poor weather resistance, because problems occur such as a decrease in transmittance and yellowing due to UV rays included in sunlight. There is also a weather-resistant type of polycarbonate in which a UV-absorbing agent is added in order to improve weather resistance. In the present embodiment, as described above, a weather-resistant type of polycarbonate is applied.

The curved face portion 31 has a diameter of 6 mm, a height of 5.74 mm (including the skirt portion 36), and a lens thickness of 2.9 mm. An inside face 31r opposing the wiring substrate 20 of the curved face portion 31 has a convex shape protruding towards the wiring substrate 20.

It is desirable that the holding portion 32 is formed like a brim in the direction intersecting the optical axis of the curved face portion 31 which is round in plan view, and has a polygonal shape having at least four corner portions in plan view.

In the present embodiment, the lens unit 30 is formed by injection molding, and is provided with a gate-corresponding portion 32g that is disposed at an outside position where the holding portion 32 is extended and corresponds to a gate portion of the injection molding die, and a step 32s that has been formed between the gate-corresponding portion 32g and the holding portion 32. Note that the size of the step 32s is 0.2 mm.

The curved face portion 31 is provided with an outer circumferential edge face 31t that has been formed in the direction intersecting the holding portion 32 at the border with the holding portion 32. In the outer circumferential edge face 31t, the side of the holding portion 32 is enlarged to the outside compared to the side of the curved face portion 31. As described above, the lens thickness is 2.99 mm, the height of the outer circumferential edge face 31t is 2.44 mm, and the inclination angle of the outer circumferential edge face 31t is 5.2 degrees (the side of the holding portion 32 is enlarged to the outside compared to the side of the top face of the curved face portion 31).

Also, in the outer circumferential edge face 31t, the side of the holding portion 32 is enlarged to the outside relative to the side of the top face of the curved face portion 31. Accordingly, when forming the lens units 30 and the frame body portion 40 as a single body by a double molding method, it is possible to improve separation from the injection molding die.

When synthetic resin is injected, it is desirable to remove moisture attached to the surface of the surface mount-type light-emitting devices 10, or inside faces of the lens units 30. This is because residual moisture may generate air bubbles after injection of synthetic resin. It is possible to evaporate moisture by performing a heat treatment.

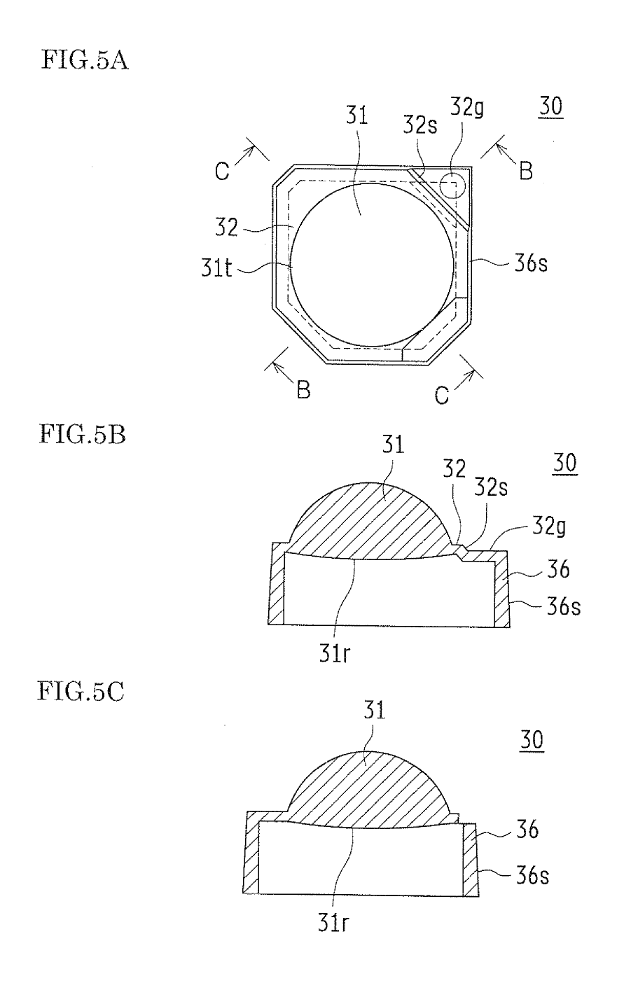

FIG. 5A is a plan view of a modified example of the lens unit shown in FIGS. 4A to 4C, FIG. 5B is a cross-sectional view at arrows B-B in FIG. 5A, and FIG. 5C is a cross-sectional view at arrows C-C in FIG. 5A.

The lens unit of the modified example differs from the lens unit shown in FIGS. 4A to 4C in that the outer circumferential edge face 31t is not provided at the boarder between the curved face portion 31 and the holding portion 32. That is, in the modified example, the curved face portion 31 and the holding portion 32 are formed continuously. Note that in the present invention, the lens unit of the modified example may be applied in place of the lens unit shown in FIGS. 4A to 4C.

FIG. 6A is a plan view of a part of a lens array module formed by double molding lens units and a frame body portion, applied to the display apparatus according to an embodiment of the present invention, and FIG. 6B is a see-through side view when viewed in a see-through manner from the direction of arrow B in FIG. 6A.

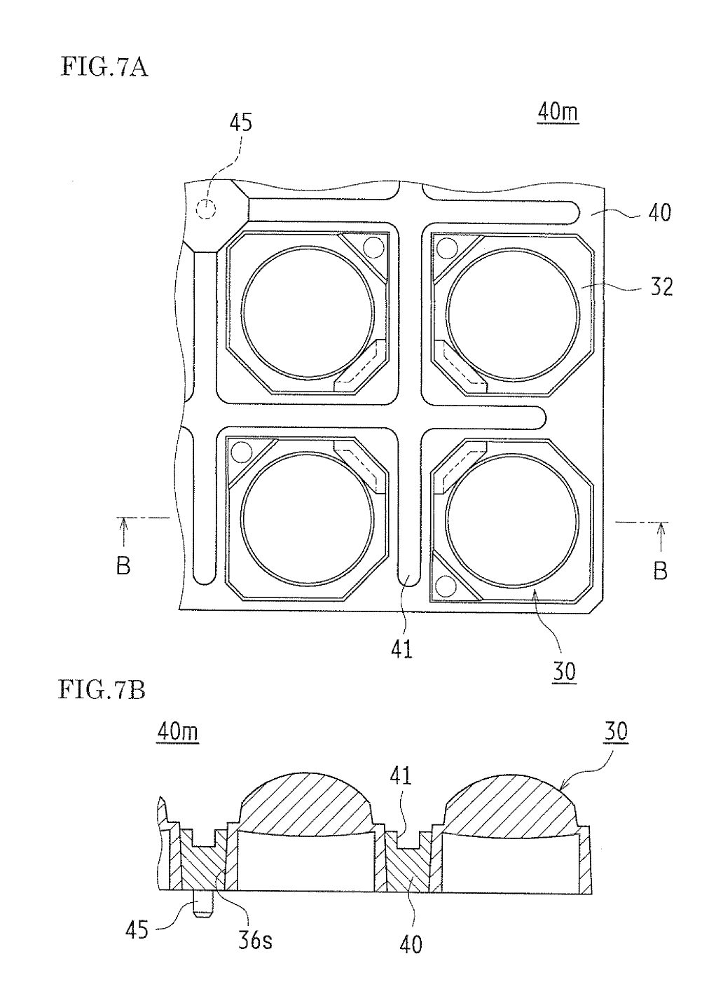

FIGS. 7A and 7B show an enlarged view of a portion of the lens array module shown in FIGS. 6A and 6B, where FIG. 7A is a plan view, and FIG. 7B is a cross-sectional view at arrows B-B in FIG. 7A.

The frame body portion 40 is configured into a lens array module 40m in which the lens units 30 are disposed in the form of a dot matrix having 16 rows×16 columns, the entire matrix constituting the lens array module 40m. That is, the frame body portion 40 is disposed surrounding the lens units 30, thus fixing the position of the lens units 30. The surface mount-type light-emitting devices 10 that have been mounted to the wiring substrate 20 are disposed corresponding to the respective lens units 30 (see FIGS. 8A and 8B).

The lens array module 40m is formed using a double molding method. Accordingly, after molding the lens units 30 (first side) with translucent resin, the frame body portion 40 (second side) can be molded with black resin, so the precise lens array module 40 can be efficiently formed. That is, the lens units 30 and the frame body portion 40 (the lens array module 40m) can be precisely and easily formed.

Accordingly, by double molding the lens units 30 and the frame body portion 40, it is possible to precisely and productively form the lens array module 40m.

Grooves 41 for draining rainwater and the like are formed in the frame body portion 40. With this configuration, rainwater and the like can be easily removed by the grooves, thereby improving whether resistance. Note that the width and the depth of the grooves 41 are set to, for example, 1 mm and 1 mm, respectively.

The frame body portion 40 that forms the lens array module 40m is made to have light-blocking properties in order to block light between adjacent surface mount-type light-emitting devices 10 and filled resin portions 38, and for example, is formed of a black resin such as black (carbon black) polycarbonate resin or black silicone resin. The polycarbonate resin is excellent with respect to transparency, impact resistance, heat resistance, flame resistance, and so forth, and therefore can be used to improve weather resistance, and therefore is particularly effective when the display apparatus 1 will be installed outdoors.

The frame body portion 40 is provided with positioning pins 45 that operate as a positioning means and engaging means when the frame body portion 40 is attached to the wiring substrate 20, and project toward the wiring substrate 20. In the present embodiment, 16 positioning pins 45 are disposed. Note that for the sake of description, the side of the lens array modules 40m to which the wiring substrate 20 is attached may be referred to as a back face side.

In the present embodiment, 256 surface mount-type light-emitting devices 10 and lens units 30 are disposed in the entire display apparatus 1.

As described above, in the display apparatus 1 according to the present embodiment, the holding portion 32 is provided with the skirt portion 36 extended to the side of the wiring substrate 20 and contacting the frame body portion 40. Accordingly, in the display apparatus 1, it is possible to easily and precisely form the lens units 30 and the frame body portion 40, and it is possible to easily and precisely form the filled resin portions 38.

Also, the skirt portion 36 grows larger to the outside further to the side of the wiring substrate 20. Accordingly, in the display apparatus 1, it is possible to precisely form the frame body portion 40 and the skirt portion 36.

The lens array module 40m (frame body portion 40) is provided, on the back face side thereof, with screw recess portions for attaching the lens array module 40m to the wiring substrate 20. That is, the lens array module 40m is attached to the wiring substrate 20 using screws (M2.6), and the screws are inserted into the screw recess portions from the side of the wiring substrate 20.

FIG. 8A is a schematic side view illustrating a state in which, in a production step of the display apparatus according to an embodiment of the present invention, a wiring substrate to which a lens array module has been attached is attached to a case, and a filled resin portion has been formed by filling a space between the surface mount-type light-emitting devices and the lens units with translucent resin, and FIG. 8B is an enlarged cross-sectional view of the portion of reference sign B in FIG. 8A.

First, the surface mount-type light-emitting devices 10 are mounted to the surface (display face 20d) of the wiring substrate 20, and the drive circuits 70 are mounted to a back face 20c of the wiring substrate 20. Then, the lens array module 40m is attached to the display face 20d, such that the surface mount-type light-emitting devices 10 and the lens units 30 correspond to each other.

With respect to the frame body portion 40, the lens array module 40m in which the lens units 30 have been disposed in the form of a dot matrix is attached to the wiring substrate 20. Accordingly, in the display apparatus 1, strength of the frame body portion 40 is insured, positioning precision of the lens units 30 relative to the surface mount-type light-emitting devices 10 is insured, and thus it is possible to improve reliability and display precision.

As described above, the display apparatus 1 is provided with the drive circuits 70 that drive the surface mount-type light-emitting devices 10, and the drive circuits 70 are mounted to the back face 20c on the opposite side as the display face 20d of the wiring substrate 20 where the surface mount-type light-emitting devices 10 have been disposed. Accordingly, in the display apparatus 1, it is easy to mount (connect) the drive circuits 70 that drive the surface mount-type light-emitting devices 10, and thus reliability can be improved. Note that the surface mount-type light-emitting devices 10 that have been disposed on the display face 20d of the wiring substrate 20 and the drive circuits 70 that have been disposed on the back face 20c are connected to each other via through holes 21 that have been formed in advance in the wiring substrate 20.

The wiring pattern on both faces of the wiring substrate 20 is connected via the through holes 21, so the surface mount-type light-emitting devices 10 that have been disposed on the display face 20d and the drive circuits 70 that have been disposed on the back face 20c are compactly connected.

As described above, the lens array module 40m is fixed by screwing to the wiring substrate 20. The lens array module 40m is screwed to the case 50.

As described above, the wiring substrate 20 and the lens array module 40m are fixed by screws 80. With this configuration, the wiring substrate 20 and the lens array module 40m can be firmly fixed with the screws 80.

As described above, the display apparatus 1 is provided with the surface mount-type light-emitting devices 10 that are surface-mounted to the wiring substrate 20, the lens units 30 disposed opposing the surface mount-type light-emitting devices 10, and the frame body portion 40 disposed surrounding the circumference of the lens units 30. The frame body portion 40 and the lens units 30 are formed as a single body to form the lens array module 40m. The frame body portion 40 includes the positioning pins 45 that project toward the wiring substrate 20. The wiring substrate 20 includes the positioning recess portions 22 in the positions corresponding to the positioning pins 45.

With this configuration, positional deviation of the surface mount-type light-emitting devices 10 with respect to the lens units 30 can be suppressed by the positioning pins 45 and the positioning recess portions 22. Therefore, luminous intensity at the front of the lens units 30 can be improved, and thus visibility of the display apparatus 1 can be improved. Also, a waterproof effect is achieved by the lens array module 40m formed by forming the frame body portion 40 and the lens units 30 as a single body, and thus weather resistance can be improved.

As described above, the lens units 30 are disposed in the form of a dot matrix, the frame body portion 40 is formed in a grid form, and a plurality of positioning pins 45 and a plurality of positioning recess portions 22 are provided. This configuration is suitable for realizing a large screen of the display apparatus 1, and since the position of the surface mount-type light-emitting devices 10 with respect to the lens units 30 is fixed at a plurality of locations, it is possible to suppress positional deviation for all surface mount-type light-emitting devices 10.

As described above, the filled resin portions 38 formed by filling a space between the surface mount-type light-emitting devices 10 and the lens units 30 with synthetic resin are provided. The wiring substrate 20 is provided with the substrate through holes 23 disposed surrounding the circumference of the surface mount-type light-emitting devices 10. With this configuration, since the surface mount-type light-emitting devices 10 are covered with synthetic resin, the surface mount-type light-emitting devices 10 can be reliably protected, and the wiring substrate 20 can be attached to the lens array module 40m by hardening the synthetic resin. Also, excessive synthetic resin can be adjusted with the substrate through holes 23, thereby reducing air bubbles remaining in the synthetic resin.

Also, in the display apparatus 1, the environmental tolerance (reliability) of the surface mount-type light-emitting devices 10 is improved, and by eliminating an air layer between the surface mount-type light-emitting devices 10 and the lens units 30, it is possible to improve light transmission (light intensity, i.e., display properties, in front of the display apparatus 1). Excess synthetic resin supplied when forming the filled resin portions 38 can be adjusted by the substrate through holes 23.

The synthetic resin is desirably a translucent resin. That is, by using translucent resin for the synthetic resin, it is possible to easily realize the necessary luminous intensity. In the description below, reference may be made to only one of synthetic resin or translucent resin.

It is desired that the translucent resin that forms the filled resin portions 38 fits well with the lens units 30, the surface mount-type light-emitting devices 10, the wiring substrate 20, and the frame body portion 40. Specifically, epoxy resin, silicone resin, or the like is preferred. Moreover, in order to further increase the fitting, the translucent resin is injected after applying a primer to the surface of the wiring substrate 20 (display face 20d), the surface of the package portion 12 of the surface mount-type light-emitting devices 10, the frame body portion 40, and so forth. Thus, the fitting improves.

For example, resin hardening and air bubble removal is performed by leaving the injected translucent resin at room temperature for 24 hours, for example. Afterward, this resin is hardened by performing a heat treatment with hardening conditions of 80° C., 45 minutes, thus forming the filled resin portions 38.

As described above, the inside face 31r (see FIGS. 5A to 5C) opposing the wiring substrate 20 of the curved face portion 31 has a convex shape bulging toward the wiring substrate 20. Accordingly, in the display apparatus 1, when the space between the surface mount-type light-emitting devices 10 and the curved face portions 31 has been filled with the synthetic resin (translucent resin), it is possible to prevent air bubbles from remaining in the filled resin portion 38.

In the above description, the drive circuits 70 are disposed on the back face 20c, but if the layout is changed, it is also possible to dispose the drive circuits 70 on the display face 20d. In such a case, it is desirable that the drive circuits 70 are disposed only on either one of those faces.

That is, in the display apparatus 1 according to the present invention, it is desirable that the drive circuits 70 that drive the surface mount-type light-emitting devices 10 are provided, and the drive circuits 70 are mounted only on either one of the display face 20d of the wiring substrate 20 where the surface mount-type light-emitting devices 10 have been disposed or the back face 20c on the opposite side.

Accordingly, in the display apparatus 1 according to the present invention, when the drive circuits 70 are disposed only on the display face 20d of the wiring substrate 20, it is possible to simultaneously mount the surface mount-type light-emitting devices 10 and the drive circuits 70 to the wiring substrate 20, thus improving productivity. Also, in the display apparatus 1 according to the present invention, when the drive circuits 70 are disposed only on the back face 20c of the wiring substrate 20, it is possible to form the wiring substrate 20 to match the outer shape of the display apparatus 1, and to dispose the surface mount-type light-emitting devices 10 so as to match the outer shape of the wiring substrate 20.

As described above, in the display apparatus 1 according to the present embodiment, the wiring substrate 20, on which the surface mount-type light-emitting devices 10, the drive circuits 70, and the lens array modules 40m have been mounted, is attached to the case 50.

From the viewpoint of ease of molding, the material of the case 50 is preferred to be polycarbonate resin, ABS resin, epoxy resin, phenol resin, or the like. In the present embodiment, the case 50 is formed with polycarbonate resin.

The case 50 is a member that mechanically protects from outside the surface mount-type light-emitting devices 10 arranged in the form of a matrix on the display face 20d of the wiring substrate 20, the drive circuits 70 mounted on the back face 20c of the wiring substrate 20, the wiring substrate 20, and so forth, and therefore the case 50 can be formed at a desired size.

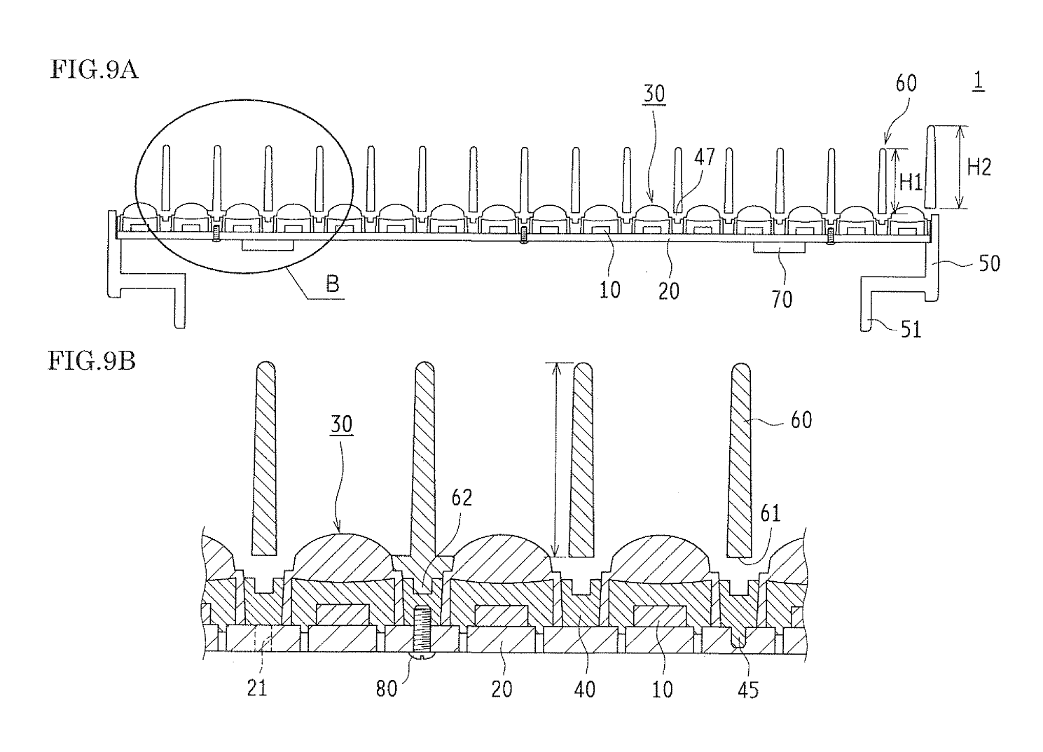

FIG. 9A is a schematic side view of a side face that illustrates a state in which, in a production step of the display apparatus according to an embodiment of the present invention, visor portions have been attached, and FIG. 9B is an enlarged cross-sectional view of the portion of reference sign B in FIG. 9A.

Visor portions 60 are disposed corresponding to the respective surface mount-type light-emitting devices 10 (the lens units 30 and the frame body portion 40). The visor portions 60 are disposed corresponding to the row direction of the frame body portion 40 (the lens array modules 40m). That is, as shown in FIGS. 1A and 1B, 16 visor portions 60 are disposed corresponding to the 16 rows of surface mount-type light-emitting devices 10 provided in the display apparatus 1. The reason that the visor portions 60 are disposed in the row direction is in order to prevent a reduction in visibility due to incident light (external light) such as sunlight from above in the vertical direction. Note that the visor portions 60 preferably are colored with a color such as black in order to improve light-blocking efficiency, and black (carbon black) polycarbonate resin can be applied as the visor portions 60.

The height H1 of the visor portions 60 is set to 10 mm, and the height H2 of the visor portion 60 disposed uppermost in the vertical direction is set to 12.5 mm. The height of the visor portions 60 is designed so as to insure a viewing angle in the vertical direction of 10 degrees, and such that direct sunlight is prevented as much as possible from being directly incident on the surface mount-type light-emitting devices 10. Accordingly, the display apparatus 1 can have both visibility and light-blocking properties.

The visor portions 60 are provided with projection portions 62 that project so as to be fitted into the grooves 41 of the frame body portion 40, and the projection portions 62 are attached to the grooves 41. The visor portions 60 include five projections 62 and a space for water elimination is formed between the visor portions 60 and the grooves 41. With this configuration, a reduction in visibility due to irradiation light can be suppressed. Also, the projection portions 62 allow easy attachment of the visor portions 60.

Also, for water elimination, the visor portions 60 are provided with water removal portions 61 with a height of 1 mm and a width of 4 mm between the visor portions 60 and the case 50.

Polycarbonate is a resin material that exhibits high physical properties with respect to transparency, impact resistance, heat resistance, flame resistance, and so forth. Also, polycarbonate has low cost relative to its superior physical properties, and therefore even in the present embodiment, as described above, black (carbon black) polycarbonate resin can be variously applied, such as to the frame body portion 40, the case 50, and the visor portions 60. Below, a modified example for polycarbonate will be described.

A UV-reflecting agent may be mixed into the polycarbonate. In this case, it is possible to prevent deterioration of members (such as the frame body portion 40, the case 50, and the visor portions 60) clue to UV rays included in sunlight, so the reliability of the display apparatus 1 can be improved.

Resin containing a UV-reflecting agent is formed by mixing and dispersing the UV-reflecting agent in polycarbonate resin or silicone resin used as translucent resin material, and converting the result to resin. As the UV-reflecting agent, it is possible to apply fine powder of silicon oxide and fine powder of a metal oxide such as aluminum oxide, zinc oxide, titanium oxide, or magnesium oxide.

An infrared-reflecting agent may further be applied in the polycarbonate. As an infrared-reflecting member, TiO₂ powder is formed by heating titanium hydroxide in a Grade 4 titanium saline solution, and passing this through a sieve. The TiO₂ powder is mixed into silicone resin and agitated to obtain a slurry of resin containing an infrared-reflecting member. The infrared-reflecting member can be applied to the case 50, the wiring substrate 20, and the visor portions 60, excepting the opening portion of the surface mount-type light-emitting devices 10.

Next, a method for producing the display apparatus 1 will be described.

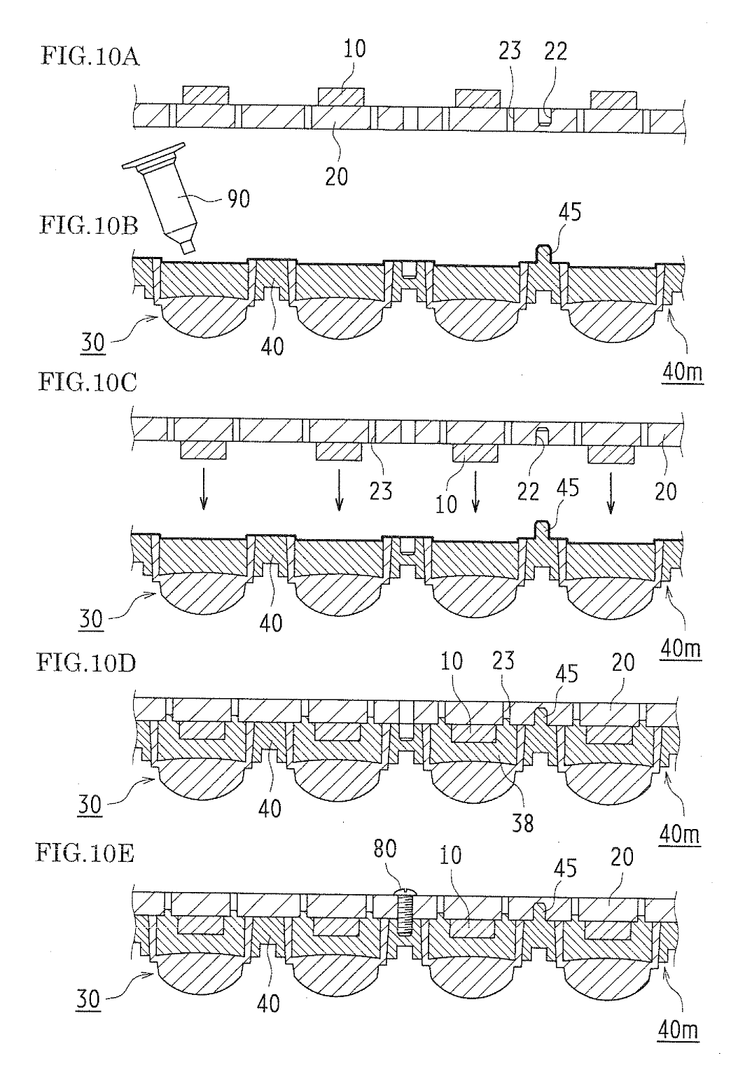

FIGS. 10A to 10E illustrate an embodiment of the method for producing a display apparatus of the present invention over time, and are schematic cross-sectional views of each production step.

First, in the step illustrated in FIG. 10A, a wiring substrate 20 to which the surface mount-type light-emitting devices 10 are surface-mounted is prepared. That is, the surface mount-type light-emitting devices 10 are surface-mounted to the wiring substrate 20.

Apart from FIG. 10A, a lens array module 40m in which the lens units 30 and the frame body portion 40 are formed as a single body is prepared. That is, the lens array module 40m is formed by a double molding method.

Next, a heat treatment is performed on the wiring substrate 20 and the lens array module 40m at 150° C. for one hour. By performing the heat treatment in advance, the wiring substrate 20 and the lens array module 40m are dried, thereby preventing generation of air bubbles when synthetic resin is hardened. Note that at the time of heat treatment, the wiring substrate 20 is processed with the side to which the surface mount-type light-emitting devices 10 are mounted facing downward, and the lens array module 40m is processed with the back face side thereof facing downward.

In the step illustrated in FIG. 10B, the lens array module 40m is disposed with the back face side thereof facing upward, and synthetic resin is filled by using an injector 90 in a state in which the inside faces 31r of the lens array module 40m are exposed. Here, synthetic resin is applied to the positioning pin 45.

In the step illustrated in FIG. 10C, the surface mount-type light-emitting devices 10 are disposed in the synthetic resin by superposing the wiring substrate 20 on the lens array module 40m such that the positioning pins 45 correspond to the positioning recess portions 22. Here, excessively-supplied synthetic resin is adjusted by the substrate through holes 23. Also, air bubbles mixed in the synthetic resin can be discharged from the substrate through holes 23.

In the step illustrated in FIG. 10D, the synthetic resin is hardened by a hardening treatment at 80° C. for 45 minutes, thereby attaching the lens array module 40m to the wiring substrate 20. The hardened synthetic resin serves as the filled resin portions 38.

In the step illustrated in FIG. 10E, the screws 80 are attached from the side of the wiring substrate 20.

As described above, an embodiment of the method for producing a display apparatus according to the present invention is a method for producing the display apparatus 1 provided with the surface mount-type light-emitting devices 10 that are surface-mounted to the wiring substrate 20, the lens units 30 disposed opposing the surface mount-type light-emitting devices 10, and the frame body portion 40 disposed surrounding the circumference of the lens units 30, including the following production steps (i) to (v):

(i) a step of preparing the lens array module 40m in which the lens units 30 and the frame body portion 40 are formed as a single body;

(ii) a step of preparing the wiring substrate 20 to which the surface mount-type light-emitting devices 10 are surface-mounted;

(iii) a step of filling an opening in the lens array module 40m with synthetic resin;

(iv) a step of disposing the surface mount-type light-emitting devices 10 in the synthetic resin filled in the opening by superposing the wiring substrate 20 on the lens array module 40m such that the positioning pins 45 provided in the frame body portion 40 correspond to the positioning recess portions 22 provided in the wiring substrate 20; and

(v) a step of hardening the synthetic resin, thereby attaching the lens array module 40m to the wiring substrate 20.

With the configuration described above, it is possible to attach the lens array module 40m to the wiring substrate 20 when the filled resin portions 38 are formed by hardening synthetic resin, and thus the steps can be simplified.

The present invention may be embodied in various other forms without departing from the spirit or essential characteristics thereof. The embodiments disclosed in this application are to be considered in all respects as illustrative and not limiting. The scope of the invention is indicated by the appended claims rather than by the foregoing description, and all modifications or changes that come within the meaning and range of equivalency of the claims are intended to be embraced therein.

What is claimed is:

1. A display apparatus comprising:
a surface mount-type light-emitting device that is surface-mounted to a wiring substrate;
a lens unit disposed opposing the surface mount-type light-emitting device; and
a frame body portion disposed surrounding a circumference of the lens unit,
wherein the frame body portion and the lens unit are formed as a single body to form a lens array module,
the frame body portion includes a positioning pin that projects toward the wiring substrate, and
the wiring substrate includes a positioning recess portion in a position corresponding to the positioning pin.

2. The display apparatus according to claim 1,
wherein the lens unit is disposed in a form of a dot matrix, and the frame body portion is formed in a grid form, and
a plurality of the positioning pins and a plurality of the positioning recess portions are provided.

3. The display apparatus according to claim 1 comprising:
a filled resin portion formed by filling a space between the surface mount-type light-emitting device and the lens unit with synthetic resin,
wherein the wiring substrate includes a substrate through hole disposed around the surface mount-type light-emitting device.

4. The display apparatus according to claim 2 comprising:
a filled resin portion formed by filling a space between the surface mount-type light-emitting device and the lens unit with synthetic resin,
wherein the wiring substrate includes a substrate through hole disposed around the surface mount-type light-emitting device.

5. The display apparatus according to claim 1,
wherein the wiring substrate and the lens array module are fixed with a screw.

6. The display apparatus according to claim 2,
wherein the wiring substrate and the lens array module are fixed with a screw.

7. The display apparatus according to claim 3,
wherein the wiring substrate and the lens array module are fixed with a screw.

8. The display apparatus according to claim 4,
wherein the wiring substrate and the lens array module are fixed with a screw.

9. The display apparatus according to claim 1,
wherein a groove is formed in the frame body portion.

10. The display apparatus according to claim 9,
wherein a visor portion disposed corresponding to the frame body portion is provided,
the visor portion includes a projection portion that projects so as to be fitted into the groove of the frame body portion, and
the projection portion is attached to the groove.

11. A method for producing a display apparatus that includes a surface mount-type light-emitting device that is surface-mounted to a wiring substrate, a lens unit disposed opposing the surface mount-type light-emitting device, and a frame body portion disposed surrounding a circumference of the lens unit, the method comprising the steps of:
preparing a lens array module in which the lens unit and the frame body portion are formed as a single body;
preparing the wiring substrate to which the surface mount-type light-emitting device is surface-mounted;
filling an opening in the lens array module with synthetic resin;
disposing the surface mount-type light-emitting device in the synthetic resin filled in the opening by superposing the wiring substrate on the lens array module such that a positioning pin provided in the frame body portion corresponds to a positioning recess portion provided in the wiring substrate; and
hardening the synthetic resin, thereby attaching the lens array module to the wiring substrate.

12. The method according to claim 11,
wherein synthetic resin is applied to the positioning pin in the filling step.
